(19) United States
(12) Patent Application Publication
(10) Pub. No.: US 2024/0198638 A1
(43) Pub. Date: Jun. 20, 2024

(54) VEHICULAR LAMINATED GLASS AND VEHICULAR WINDOW STRUCTURE

(71) Applicant: AGC Inc., Tokyo (JP)

(72) Inventors: Yukihiro SUMI, Tokyo (JP); Yuhei Gima, Tokyo (JP)

(73) Assignee: AGC Inc., Tokyo (JP)

(21) Appl. No.: 18/590,931

(22) Filed: Feb. 28, 2024

Related U.S. Application Data
(63) Continuation of application No. PCT/JP2022/032347, filed on Aug. 29, 2022.

(30) Foreign Application Priority Data
Sep. 1, 2021 (JP) 2021-142443

(51) Int. Cl. B32B 17/10; B60J 1/17

(52) U.S. Cl. CPC B32B 17/10495; B32B 17/10036; B60J 1/17

(57) ABSTRACT

A vehicular laminated glass having a light control film, having deterioration of the appearance as viewed from inside or outside the vehicle suppressed and a favorable field of view secured.

A vehicular laminated glass comprising a pair of glass plates provided to face each other, an interlayer provided between the pair of glass plates, and a light control film capable of switching the visible light transmittance provided inside the interlayer,
wherein the light control film has a first substrate and a second substrate provided to face each other, a light control layer provided between the first substrate and the second substrate, and a sealing material provided on the periphery of the light control layer, and
in a plan view, at least a part of the periphery of the light control film is away from the periphery of the pair of glass plates with a distance of at most 5 mm.

This application is a continuation of PCT Application No. PCT/JP2022/032347, filed on Aug. 29, 2022, which is based upon and claims the benefit of priority from Japanese Patent Application No. 2021-142443 filed on Sep. 1, 2021. The contents of those applications are incorporated herein by reference in their entireties.

### TECHNICAL FIELD

The present invention relates to a vehicular laminated glass and a vehicular window structure.

### BACKGROUND ART

As a window glass for vehicles such as automobiles and trains, a laminated glass having a light control film capable of switching the visible light transmittance sealed in an interlayer, is known. For improving privacy of a crew and passengers, such a laminated glass becomes opaque by scattering light when a voltage is applied to the light control film, and becomes transparent when no voltage is applied to the light control film. The light control film has, as a light control layer, for example, a liquid crystal device (for example, Patent Document 1).

By the way, when the light control film is exposed to the edge surface of a glass plate, the light control layer may deteriorate due to moisture, impact or the like, or may incur the risk of electric shock by contact with a human body. Therefore, usually, the light control film is disposed so that its periphery is located inside the periphery of the glass plate in the plane direction. And, on a step between the periphery of the glass plate and the periphery of the light control film at the peripheral portion of the light control film, a resin sheet to be an interlayer at the time of pressure-bonding the glass plates may be disposed in some cases (for example, Patent Document 2).

### PRIOR ART DOCUMENTS

### Patent Documents

Patent Document 1: Japanese Patent No. 3296096
Patent Document 2: WO2007/142319

### DISCLOSURE OF INVENTION

### Technical Problem

However, there has been such a problem that the periphery of the light control film as a boundary between the interlayer and the light control film is visible from inside or outside the vehicle as a parting line. And, in a case where a shielding layer to shield the parting line is provided on the laminated glass, it is necessary that the shielding layer has a width exceeding 15 mm, and such a shielding layer may obstruct checking inside or outside the vehicle.

Under these circumstances, the present invention has been made to solve the above problems, and its object is to provide a vehicular laminated glass having a light control film, which has deterioration of the appearance as viewed from inside or outside the vehicle suppressed and a favorable field of view secured.

### Solution to Problem

According to a first embodiment of the disclosure, provided is a vehicular laminated glass comprising a pair of glass plates provided to face each other, an interlayer provided between the pair of glass plates, and a light control film capable of switching the visible light transmittance provided inside the interlayer,
wherein the light control film has a first substrate and a second substrate provided to face each other, a light control layer provided between the first substrate and the second substrate, and a sealing material provided on the periphery of the light control layer, and
in a plan view, at least a part of the periphery of the light control film is away from the periphery of the pair of glass plates with a distance of at most 5 mm.

According to a second embodiment of the disclosure, provided is the vehicular laminated glass according to the first embodiment, wherein in a plan view, the distance from the periphery of the pair of glass plates to the periphery of the second substrate is longer than the distance from the periphery of the pair of glass plates to the periphery of the first substrate, and
the sealing material is in contact with the main surface of the first substrate and the peripheral side surface of the second substrate.

According to a third embodiment of the disclosure, provided is the vehicular laminated glass according to the first or second embodiment, wherein in a plan view, at least a part of the periphery of the first substrate agrees with the periphery of the pair of glass plates.

According to a fourth embodiment of the disclosure, provided is the vehicular laminated glass according to the third embodiment, wherein in a plan view, the distance from the periphery of the pair of glass plates to the periphery of the second substrate is at most 5 mm.

According to a fifth embodiment of the disclosure, provided is the vehicular laminated glass according to any one of the first to fourth embodiments, wherein in a plan view, the distance from the periphery of the first substrate to the periphery of the light control layer is at most 5 mm.

According to a sixth embodiment of the disclosure, provided is the vehicular laminated glass according to any one of the first to fifth embodiments, wherein in a plan view, the distance from the periphery of the pair of glass plates to the periphery of the light control layer is equal to the distance from the periphery of the pair of glass plates to the periphery of the second substrate.

According to a seventh embodiment of the disclosure, provided is the vehicular laminated glass according to any one of the first to fifth embodiments, wherein in a plan view, the distance from the periphery of the pair of glass plates to the periphery of the light control layer is, longer than the distance from the periphery of the pair of glass plates to the periphery of the first substrate and the distance from the periphery of the pair of glass plates to the periphery of the second substrate, or longer than the distance from the periphery of the pair of glass plates to the periphery of the first substrate and shorter than the distance from the periphery of the pair of glass plates to the periphery of the second substrate.

According to an eighth embodiment of the disclosure, provided is the vehicular laminated glass according to any one of the first to seventh embodiments, wherein in a plan view, the distance from the periphery of the pair of glass plates to the periphery of the first substrate at both side edge portions of the vehicular laminated glass, is longer than the distance from the periphery of the pair of glass plates to the periphery of the first substrate at the upper edge portion of the vehicular laminated glass.

According to a ninth embodiment of the disclosure, provided is the vehicular laminated glass according to any one of the first to eighth embodiments, wherein the second substrate is disposed on the vehicle interior side than the first substrate when the vehicular laminated glass is installed on a vehicle.

According to a tenth embodiment of the disclosure, provided is the vehicular laminated glass according to any one of the first to ninth embodiments, wherein the light control film has an ultraviolet absorbing layer at least one of between the first substrate and the light control layer and between the second substrate and the light control layer.

According to an eleventh embodiment of the disclosure, provided is the vehicular laminated glass according to any one of the first to tenth embodiments, wherein the sealing material is constituted by a foil-shaped member having a resin substrate and an adhesive layer on the main surface of the resin substrate.

According to a twelfth embodiment of the disclosure, provided is the vehicular laminated glass according to any one of the first to eleventh embodiments, wherein the sealing material contains a curable resin.

According to a thirteenth embodiment of the disclosure, provided is the vehicular laminated glass according to any one of the first to twelfth embodiments, wherein the pair of glass plates has a visible light transmittance of at least 5% at its peripheral portion.

According to a fourteenth embodiment of the disclosure, provided is the vehicular laminated glass according to any one of the first to twelfth embodiments,
which has a shielding layer on the peripheral portion of the pair of glass plates, and
wherein the shielding layer is located in a region of at most 15 mm from the periphery of the pair of glass plates.

According to a fifteenth embodiment of the disclosure, provided is a vehicular window structure, comprising the vehicular laminated glass as defined in any one of the first to fourteenth embodiments, and a support member which supports at least one of the pair of glass plates.

According to a sixteenth embodiment of the disclosure, provided is the vehicular window structure according to the fifteenth embodiment,
wherein in a plan view, the pair of glass plates has a first region which overlaps with the support member, and
the light control layer does not overlap with the first region.

According to a seventeenth embodiment of the disclosure, provided is the vehicular window structure according to the fifteenth or sixteenth embodiment, which has a lifting device which raises and lowers the vehicular laminated glass.

According to an eighteenth embodiment of the disclosure, provided is the vehicular window structure according to any one of the fifteenth to seventeenth embodiment,
which has a glass run,
wherein the glass run has a second region which overlaps with at least a part of the pair of glass plates in a plan view, and
the periphery of the first substrate and the periphery of the second substrate overlap with the second region.

### Advantageous Effects of Invention

According to the vehicular laminated glass having a light control film of the present disclosure, deterioration of the appearance as viewed from inside or outside the vehicle is suppressed, and a favorable field of view is secured.

### BRIEF DESCRIPTION OF DRAWINGS

FIGS. 1A and 1B are views (No. 1) illustrating a laminated glass according to the first embodiment, and FIG. 1A is a view schematically illustrating the laminated glass as seen from the normal direction of the second glass plate, and FIG. 1B is a partially enlarged cross-sectional view along the line A-A in FIG. 1A.

FIG. 2 is a view (No. 2) illustrating the laminated glass according to the first embodiment.

FIG. 3 is a view (No. 1) illustrating a modified example of the light control film.

FIG. 4 is a view (No. 2) illustrating a modified example of the light control film.

FIGS. 5A and 5B are views (No. 1) illustrating two types of laminated glasses in a modified example according to the first embodiment and are partially enlarged cross-sectional views corresponding to FIG. 1B.

FIGS. 6A and 6B are views (No. 2) illustrating two types of laminated glasses in a modified example according to the first embodiment, and FIG. 6A is a view schematically illustrating the laminated glass as seen from the normal direction of the second glass plate, and FIG. 6B is a partially enlarged cross-sectional view along the line B-B in FIG. 6A.

FIG. 7 is a schematic view illustrating a vehicular window structure.

### DESCRIPTION OF EMBODIMENTS

In the following, with reference to the drawings, embodiments to carry out the present invention will be described. There may be a case where in the respective drawings, to the same components, the same symbols are attached, and duplicate explanations for the same components may be omitted. Further, there may be a case where, in the respective drawings, the size and shape of some parts may be exaggerated to facilitate understanding of the contents of the present invention.

Here, the term “vehicle” is used to refer to any mobile vehicle that can be equipped with laminated glass, including a train, a ship, an aircraft, etc., although the most common vehicle is an automobile.

Further, “in a plan view” means viewing an object from the direction of the normal line passing through the center of gravity of the object's main surface, and the shape visible at that time is called a plane shape.

Further, the expressions “upper” and “lower” shall refer to the upper and lower when the laminated glass is installed on a vehicle. In addition, the expressions “upper edge portion” and “lower edge portion” shall, respectively, refer to the area of a predetermined width including the upper edge and the area of a predetermined width including the lower edge, when the laminated glass is installed on a vehicle, and the expression “side edge portion” shall refer to the area of a predetermined width including at least one of the right side edge and the left side edge, when the laminated glass is installed on a vehicle.

Further, the outer edge in a plan view of a predetermined member is called “periphery”, and, in a predetermined member, a region having a width and being in contact with the periphery is called “peripheral portion”. The “peripheral portion” is a term including the upper edge portion, the lower edge portion, and the side edge portions.

### [Laminated Glass]

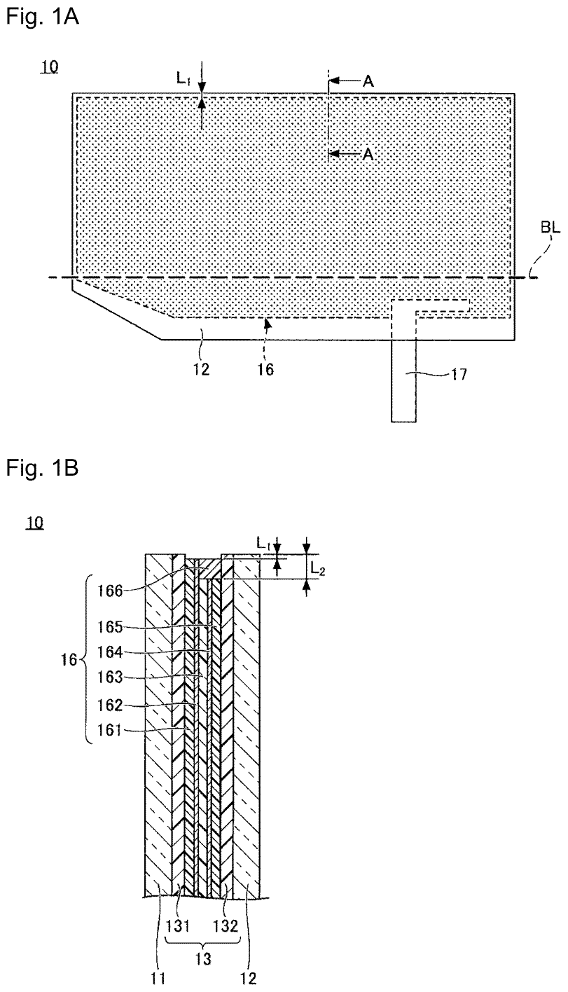

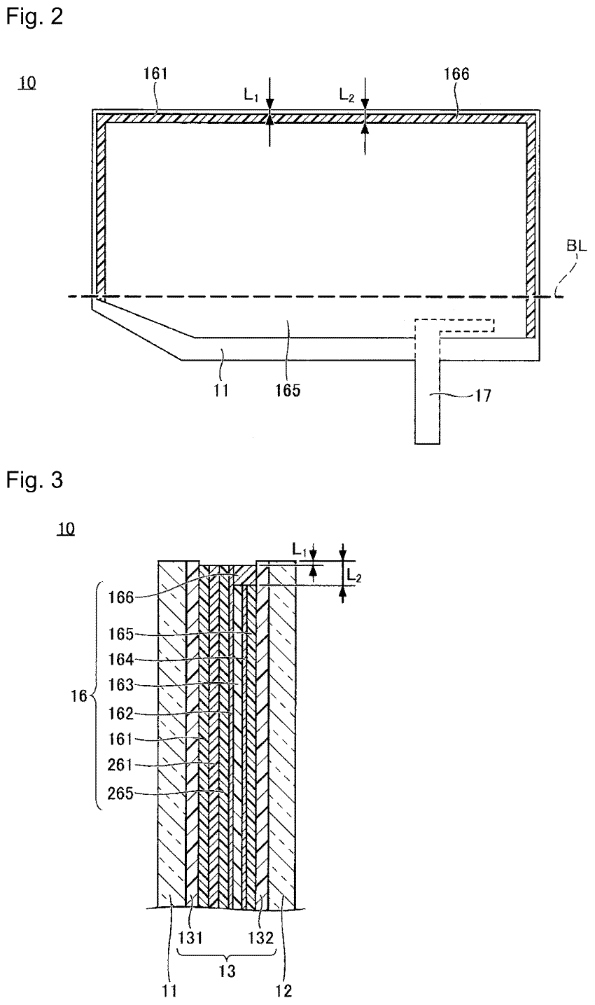

FIGS. 1A and 1B are views (No. 1) illustrating a laminated glass according to the first embodiment. FIG. 1A is a view schematically illustrating the laminated glass as seen from the normal direction of the second glass plate. FIG. 1B is a partially enlarged cross-sectional view along the line A-A in FIG. 1A. FIG. 2 is a view (No. 2) illustrating the laminated glass according to the first embodiment, and illustrates only members located closer to the first glass plate than the second glass plate, in a plan view.

As shown in FIGS. 1A and 1B and FIG. 2, the laminated glass 10 is a vehicular laminated glass having a first glass plate 11, a second glass plate 12, an interlayer 13, and a light control film 16. The laminated glass 10 has a lower edge portion, which is located on the lower side when the laminated glass 10 is installed on a vehicle, an upper edge portion, which is located on the upper side when the laminated glass 10 is installed on a vehicle, opposite to the lower edge portion, and a plurality of side edge portions connecting the lower edge portion and the upper edge portion. FIG. 1B shows a cross-sectional view in the vicinity of the upper edge portion of the laminated glass 10.

The first glass plate 11 and the second glass plate 12 are bonded via an interlayer 13. The first glass plate 11 is disposed on a first side, which is the vehicle exterior side when the laminated glass 10 is installed on a vehicle, and the second glass plate 12 is disposed on a second side, which is the vehicle interior side when the laminated glass 10 is installed on a vehicle.

In FIGS. 1A and 1B and FIG. 2, for convenience of explanation, the external shape of the laminated glass 10 is simplified. The laminated glass 10 may have a curved shape, not the flat (non-curved) shape as shown in FIG. 1B. The laminated glass 10 may be, for example, mono-curved in one of the vertical and horizontal directions when installed on a vehicle, or double-curved in both vertical and horizontal directions when installed on a vehicle. However, the mono-curved and double-curved shapes are not limited to the vertically and/or horizontally curved shapes when installed on a vehicle. The mono-curved shape includes a shape curved in only optional one direction. Further, the double curved shape includes a shape curved in any optional two or more different directions.

In a case where the laminated glass 10 is curved, the laminated glass 10 is preferably curved so that it becomes convex toward the vehicle exterior side. That is, the first glass plate 11 is preferably curved so that it becomes convex toward the opposite side of the interlayer 13, and the second glass plate 12 is preferably curved so that it becomes convex toward the interlayer 13 side. Here, in FIG. 1A and FIG. 2, in a plan view, the laminated glass 10 is shown to be substantially in a rectangular shape, but the laminated glass 10 is not limited to be substantially in a rectangular shape and may be of any optional shape. The term “substantially” here means that no geometrical rigor is required in terms of linearity, number of corners and size of corners, etc. The laminated glass 10 may be substantially in a trapezoidal shape, substantially in a triangular shape, and so on.

The laminated glass 10 may be used as a vehicular window glass or as a partition in vehicles. As a vehicular window glass, the laminated glass 10 may be used, for example, as a windshield, a rear window, a quarter window, a roof, and an extra window. Further, among vehicular window glass, the laminated glass 10 is suitable for use as a window glass slidable in an up-and-down direction. As such a window glass, a door glass of automobiles, for example, a front side door glass and a rear side door glass of automobiles may be mentioned. A door glass is likely to come into sight of passengers and from its characteristic that it slides up and down, it is significantly affected by the parting line of the light control film and the shielding layer to shield the parting line, as compared with roofs, etc. Accordingly, the effects of the present invention tend to be remarkable when used as a door glass.

The beltline BL in FIG. 1A and FIG. 2 is a boundary line between the laminated glass 10 and a door panel of a vehicle when the laminated glass 10 is installed on the vehicle. FIG. 1A and FIG. 2 schematically show the positional relationship between the laminated glass 10 and the beltline BL, in a state when the laminated glass 10 slidable in an up-and-down direction, is fully closed (in a state located at the uppermost position).

In a case where the laminated glass 10 is curved, the minimum value of the radius of curvature of the laminated glass 10 is preferably at least 500 mm and at most 100,000 mm. The radii of curvature of the first glass plate 11 and the second glass plate 12 may be the same or different. If the radii of curvature of the first glass plate 11 and the second glass plate 12 are different, the radius of curvature of the second glass plate 12 is smaller than that of the first glass plate 11.

The first glass plate 11 and the second glass plate 12 are a pair of glass plates facing each other, and the interlayer 13 and the light control film 16 are located between the pair of glass plates. The first glass plate 11 and the second glass plate 12 are fixed in a state having the interlayer 13 and the light control film 16 sandwiched between them. The interlayer 13 is a film to bond the first glass plate 11 and the second glass plate 12. The interlayer 13 has a first interlayer 131 bonded to the first glass plate 11 and a second interlayer 132 bonded to the second glass plate 12. In a case where it is not necessary to particularly distinguish the first interlayer 131 and the second interlayer 132, they will simply be referred to as the interlayer 13.

In the laminated glass 10, at least at the upper edge portion, the peripheral side surface of the interlayer 13 is exposed. Therefore, the peripheral side surface of the interlayer 13 is preferably edge-treated. That is, the peripheral side surface of the interlayer 13 is preferably treated so that it does not substantially protrude from the peripheral side surfaces of the first glass plate 11 and the second glass plate 12. The protrusion amount of the peripheral side surface of the interlayer 13 from the peripheral side surfaces of the first glass plate 11 and the second glass plate 12 is preferably at most 1 mm, whereby the appearance will not deteriorate. The protrusion amount of the peripheral side surface of the interlayer 13 from the peripheral side surfaces of the first glass plate 11 and the second glass plate 12 is more preferably at most 0.5 mm, further preferably at most 0.15 mm.

The peripheral side surface of the interlayer 13 may be embedded inwardly from the peripheral side surfaces of the first glass plate 11 and the second glass plate 12. The embedded amount of the peripheral side surface of the interlayer 13 into the peripheral side surfaces of the first glass plate 11 and the second glass plate 12 is preferably within 3 mm, whereby the strength of the laminated glass will not be impaired. The embedded amount of the peripheral side surface of the interlayer 13 into the peripheral side surfaces of the first glass plate 11 and the second glass plate 12 is more preferably within 2 mm, further preferably within 1 mm. Details of the first glass plate 11, the second glass plate 12 and the interlayer 13 will be described later.

The light control film 16 is an element capable of switching the visible light transmittance of the laminated glass 10, and is disposed inside the interlayer 13. The light control film 16 has a first substrate 161, a first conductive layer 162, a light control layer 163, a second conductive layer 164, a second substrate 165 and a sealing material 166. A case where the distance L₁ from the periphery of a pair of glass plates to the periphery of the first substrate 161 is zero (0 mm), is also included in the case where the light control film 16 is disposed inside the interlayer 13. At the lower edge portion of the laminated glass 10, the light control film 16 is connected to a wiring 17 for supplying a power from the outside of the laminated glass 10. When a voltage is applied to the light control film 16 from a power source such as a battery via the wiring 17, the visible light transmittance of the light control film 16 will be switched according to the applied voltage. Note that even when the laminated glass 10 is installed on a vehicle and the laminated glass 10 is completely closed, the wiring 17 is located below the belt line BL. Therefore, the wiring 17 is not visible when the laminated glass 10 is installed on the vehicle.

The light control film 16 is sandwiched between the first interlayer 131 and the second interlayer 132. The first conductive layer 162, the light control layer 163, the second conductive layer 164, the second substrate 165 and the sealing material 166 are disposed on the interior side of the vehicle than the first substrate 161, when the laminated glass 10 is installed on the vehicle.

The first substrate 161 and the second substrate 165 are transparent resin layers disposed to face each other. The thickness of each of the first substrate 161 and the second substrate 165 is, for example, at least 5 μm and at most 500 μm. The first substrate 161 and the second substrate 165 may, for example, be formed of at least one member selected from the group consisting of polyethylene terephthalate, polyethylene naphthalate, polyamide, polyether, polysulfone, polyethersulfone, polycarbonate, polyarylate, polyetherimide, polyether ether ketone, polyimide, aramid, polybutylene terephthalate, triacetyl cellulose, polyurethane and cycloolefin polymer.

The first conductive layer 162 is formed on the whole area of the surface of the first substrate 161 facing the second glass plate 12, and is in contact with the surface of the light control layer 163 facing the first glass plate 11. The second conductive layer 164 is formed on the whole area of the surface of the second substrate 165 facing the first glass plate 11, and is in contact with the surface of the light control layer 163 facing the second glass plate 12. That is, the first conductive layer 162 and the second conductive layer 164 sandwich the light control layer 163 from both sides. However, the first conductive layer 162 may be formed on a part of the surface of the first substrate 161 facing the second glass plate 12, and the second conductive layer 164 may be formed on a part of the surface of the second substrate 165 facing the first glass plate 11.

The first conductive layer 162 and the second conductive layer 164 are not particularly limited so long as they are formed of a transparent conductive material, and for example, a transparent conductive oxide (TCO) may be used. TCO may, for example, be tin-doped indium oxide (ITO), aluminum doped zinc oxide (AZO) or indium doped cadmium oxide, but is not limited thereto.

The light control layer 163 is sandwiched between the first substrate 161 having the first conductive layer 162 formed thereon and the second substrate 165 having the second conductive layer 164 formed thereon. The light control layer 163 is at least one member selected from, for example, a suspended particle device (SPD), a polymer dispersed liquid crystal device (PDLC), a polymer network liquid crystal device (PNLC), a guest host liquid crystal device (GHLC), a photochromic device, an electrochromic device, and an electrokinetic device. The light control layer 163 is preferably at least one member selected from a suspended particle device, a polymer dispersed liquid crystal device, a polymer network liquid crystal device, a guest host liquid crystal device and an electrochromic device. The thickness of the light control film 16 is, for example, at least 0.1 mm and at most 1 mm. The thickness of the light control film 16 may be at most 0.8 mm, or at most 0.5 mm. The thickness of the light control film 16 may be at least 0.3 mm.

SPD is a member having an active layer containing suspended particles. For example, the active layer is sandwiched between transparent substrates having a transparent electrode formed thereon and is film-shaped as a whole. Light absorption by the active layer is variable by applying a voltage to the electrode. The light absorption is based on the state of alignment of particles in the suspension drops dispersed in the active layer. The degree of light absorption may be represented, for example, by the visible light transmittance. SPD is known, for example, from WO2005/102688 or WO2012/009399.

PDLC is a member having an active layer having liquid crystal droplets dispersed and maintained in a polymer matrix. For example, the active layer is sandwiched between transparent substrates having a transparent electrode formed thereon and is film-shaped as a whole. Light scattering by the active layer is variable by applying a voltage to the electrode. The light scattering is based on the state of alignment of the liquid crystal droplets. The degree of light scattering may be represented, for example, by the haze. PDLC is known, for example, from JP-A-H07-239465 and U.S. Pat. No. 4,688,900. PNLC is one having a low resin content ratio and having the liquid crystal material aligned along a three-dimensional network polymer network structure. PNLC is known, for example, from U.S. Pat. No. 5,304,323.

GHLC is a member having an active layer formed by mixing a dichroic dye (guest) having anisotropy in light absorption between the major axis direction and the minor axis direction of the molecules, with a liquid crystal material (host). For example, the active layer is sandwiched between transparent substrates having a transparent electrode formed thereon and is film-shaped as a whole. Light absorption by the active layer is variable by applying a voltage to the electrode. The light absorption is based on the state of alignment of the liquid crystal materials and the dichroic dye contained in the active layer. GHLC is known, for example, from Japanese Patent No. 5729092.

An electrochromic device is a member having an electrochemically active layer. For example, the active layer is sandwiched between transparent substrates having a transparent electrode formed thereon and is film-shaped as a whole. Light absorption by the active layer is based on a variable oxidation state of an electrolyte by reversible injection/release of the charge by applying a voltage to the pair of electrodes. The electrochromic device is known, for example, from JP-A-2009-265437 and WO2016/145120.

The light control film 16 may have an ultraviolet absorbing layer at least one of between the first substrate 161 and the light control layer 163, and between the second substrate 165 and the light control layer 163. The ultraviolet absorbing layer may be a layer containing an ultraviolet absorber. The layer containing an ultraviolet absorber may, for example, be a coating layer or a transparent adhesive material.

FIG. 3 illustrates an example in which the light control film 16 has an ultraviolet absorbing layer 261 between the first substrate 161 and the light control layer 163. The example shown in FIG. 3 is different from the example shown in FIG. 1B in that the ultraviolet absorbing layer 261 and a third substrate 265 are added. The surface of the ultraviolet absorbing layer 261 facing the first glass plate 11 is in contact with the surface of the first substrate 161 facing the second glass plate 12, and the surface of the ultraviolet absorbing layer 261 facing the second glass plate 12 is in contact with the surface of the third substrate 265 facing the first glass plate 11. The first conductive layer 162 is formed on the whole area of the surface of the third substrate 265 facing the second glass plate 12, and is in contact with the surface of the light control layer 163 facing the first glass plate 11. The ultraviolet absorbing layer 261 may be a transparent adhesive material containing an ultraviolet absorber.

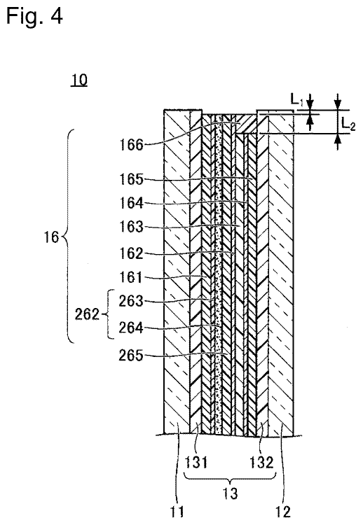

FIG. 4 illustrates an example in which the light control film 16 has an ultraviolet absorbing layer 262 between the first substrate 161 and the light control layer 163. The example shown in FIG. 4 is different from the example shown in FIG. 1B in that the ultraviolet absorbing layer 262 and the third substrate 265 are added. The ultraviolet absorbing layer 262 has a coating layer 263 containing an ultraviolet absorber and a transparent adhesive material 264. The transparent adhesive material 264 may or may not contain an ultraviolet absorber. The surface of the coating layer 263 facing the first glass plate 11 is in contact with the surface of the first substrate 161 facing the second glass plate 12, and the surface of the coating layer 263 facing the second glass plate 12 is in contact with the surface of the transparent adhesive material 264 facing the first glass plate 11. The surface of the transparent adhesive material 264 facing the second glass plate 12 is in contact with the surface of the third substrate 265 facing the first glass plate 11. The first conductive layer 162 is formed on the whole area of the surface of the third substrate 265 facing the second glass plate 12, and is in contact with the surface of the light control layer 163 facing the first glass plate 11.

The sealing material 166 is disposed on the periphery of the light control layer 163. The sealing material 166 may be in contact with the light control layer 163. The sealing material 166 seals the light control film 16 so that at least the peripheral side surface of the light control layer 163 will not be exposed to the outside of the laminated glass, whereby deterioration of the light control layer 163 by moisture, impact or the like can be suppressed. The visible light transmittance (Tv) of the sealing material 166 is preferably at least 5%, more preferably at least 10%, further preferably at least 20%, still more preferably at least 50%. The higher the visible light transmittance (Tv) of the sealing material 166, the more favorable field of view can be secured, and the more easily the inside or outside of the vehicle can be checked. The visible light transmittance (Tv) may be measured by the method in accordance with JIS R3106:2019. Further, the sealing material 166 may not be in contact with the light control layer 163. That is, there may be a gap between the sealing material 166 and the light control layer 163.

The sealing material 166 is, for example, a foil-shaped member (so-called tape) having a resin substrate and an adhesive layer provided on the main surface of the resin substrate. In a case where the sealing material 166 is a foil-shaped member, the thickness is preferably at most 50 μm. The resin substrate of the sealing material 166 is suitably formed of polyethylene terephthalate (PET), polyethylene, polypropylene, polyimide, polycarbonate, polyvinyl chloride or polytetrafluoroethylene. The adhesive material of the sealing material 166 is suitably an acrylic resin, a silicone resin, an urethane resin or the like.

The sealing material 166 may contain, for example, a curable resin, and may be formed solely of a curable resin. The curable resin may, for example, be an acrylic resin, an epoxy resin, a silicone resin or a butyl resin. In a case where the sealing material 166 is a foil-shaped member, the adhesive layer may be formed of the above curable resin. The curable resin may be a resin which is curable by heat, light or moisture, or a resin of a two-liquid curable system consisting of a main material and a curing agent. The curable resin may be either transparent or opaque, and may be either colorless or colored. The color of the curable resin is not particularly limited and may, for example, be black or white. The curable resin is preferably transparent or colorless, so as to be less noticeable.

The sealing width of the light control film 16 in a plan view is preferably at least 2 mm and at most 20 mm. By setting the sealing width to be at least 2 mm, it is possible to sufficiently suppress deterioration of the edges of the light control film. By setting the sealing width to be at most 20 mm, it is possible to reduce deterioration in appearance.

In the laminated glass 10, in a plan view of the pair of glass plates, at least at a part of the periphery of the light control film 16, the distance from the periphery of the pair of glass plates is at most 5 mm, whereby the distance between the periphery of the light control film to be the parting line and the periphery of the pair of glass plates is very short, and the parting line is less noticeable, and thus deterioration of the appearance of the laminated glass 10 as viewed from inside or outside the vehicle can be suppressed.

In the following description, a plan view of the pair of glass plates will be referred to simply as a “plan view”. In a case where there is a plate misalignment between the first glass plate 11 and the second glass plate 12, the “plan view” means a plan view of the glass plate located inside (on the inner side) in the plane direction. Further, the distance from the periphery of the pair of glass plates is also based on the periphery of the glass located inside (on the inner side) in the plane direction.

In the laminated glass 10, as the parting line is less noticeable, it is not necessary to provide a shielding layer to shield the parting line at the peripheral portion of the laminated glass 10. Therefore, a favorable field of view can be secured, and the inside or outside of the vehicle can easily be checked. At the peripheral portion of the pair of glass plates, the visible light transmittance (Tv) of the laminated glass 10 is preferably at least 5%, more preferably at least 10%, further preferably at least 15%. The higher the visible light transmittance (Tv) of the laminated glass 10, the more favorable field of view can be secured, and the more easily the inside or outside of the vehicle can be checked.

In a case where the laminated glass 10 is used as a slidable window glass, the laminated glass 10 is raised and lowered in a state where both side edge portions of the laminated glass 10 are held by a glass run. The glass run is a sealing component formed of e.g. a resin to be attached to a window frame of a vehicle, and it seals the gap between the laminated glass 10 and the window frame of the vehicle to prevent noise, wind, rain, etc. from entering into the vehicle. The glass run is provided on the sides of the upper edge portion and both side edge portions of the laminated glass 10, and the laminated glass 10 is raised and lowered in a state where both side edge portions are held by the glass run. When the laminated glass 10 is moved to the uppermost position by sliding, the upper edge portion of the laminated glass 10 is held by the glass run. If a shielding layer to shield the parting line is provided at the peripheral portion of the laminated glass 10, in a state where the upper edge portion of the laminated glass 10 is not held by the glass run, the shielding layer provided on the upper edge portion of the laminated glass 10 is visible, and the appearance may deteriorate. However, in the laminated glass 10, it is not necessary to provide a shielding layer, and thus the appearance will not deteriorate even in a state where the upper edge portion of the laminated glass 10 is not held by the glass run.

Now, the positional relationship between the first substrate 161, the second substrate 165 and the sealing material 166 will be described in further detail. In FIGS. 1A and 1B and FIG. 2, in a plan view, at least at the upper edge portion and both side edge portions of the laminated glass 10, the distance L₁ from the periphery of the first substrate 161 constituting the light control film 16 to the periphery of the pair of glass plates is preferably at most 5 mm. When the distance L₁ is at most 5 mm, the periphery of the first substrate 161 will be less noticeable, and deterioration of the appearance of the laminated glass 10 as viewed from inside or outside the vehicle can be suppressed. The distance L₁ may be set to such a value at least at the upper edge portion of the laminated glass 10 and at both side edge portions of the laminated glass 10 located closer to the upper edge portion than the belt line BL, in a plan view when the laminated glass 10 is installed on the vehicle.

In a plan view, at least at the upper edge portion and both side edge portions of the laminated glass 10, the distance L₁ from the periphery of the first substrate 161 to the periphery of the pair of glass plates may be at most 4 mm, may be at most 3 mm, may be at most 2 mm, and may be at most 1 mm. Further, in a plan view, at least at the upper edge portion and both side edge portions of the laminated glass 10, the periphery of the first substrate 161 may agree with the periphery of the pair of glass plates. Ultimately, the distance L₁ may be 0. Here, “agree with” includes a range of at least 0 mm and less than 1 mm considering production errors. The closer to 0 the distance L₁ is, the higher the effect to suppress deterioration of the appearance of the laminated glass 10 as viewed from inside or outside the vehicle will be. Further, the distance L₁ from the periphery of the first substrate 161 to the periphery of the pair of glass plates may be at least 0.5 mm, and may be at least 1 mm. When the distance L₁ is at least 0.5 mm, for example, the edge of the light control film 16 is less likely to get wet, and deterioration of durability is likely to be suppressed. The distance L₁ may be set to such a value at least at the upper edge portion of laminated glass 10 and at both side edge portions of the laminated glass 10 located closer to the upper edge portion than the belt line BL, in a plan view when the laminated glass 10 is installed on the vehicle.

In a plan view, the distance from the periphery of the pair of glass plates to the periphery of the first substrate 161 at both side edge portions of the laminated glass 10, may be longer than the distance from the periphery of the pair of glass plates to the periphery of the first substrate 161 at the upper edge portion of the laminated glass 10, whereby it will be easy to satisfy both effect of suppressing deterioration of the appearance of the laminated glass 10 as viewed from inside or outside the vehicle and effect to suppress deterioration of the durability of the light control film 16.

In a plan view, at the lower edge portion and at a portion closer to the lower edge portion than the upper edge portion of both side edge portions of the laminated glass 10, the distance from the periphery of the first substrate 161 to the periphery of the pair of glass plates may be longer than 5 mm. The distance from the periphery of the pair of glass plates to the periphery of the first substrate 161 may be set to such a value at least at the lower edge portion of the laminated glass 10 and both side edge portions of the laminated glass 10 located closer to the lower edge portion than the belt line BL, in a plan view when the laminated glass 10 is installed on the vehicle This is because the portion of the laminated glass closer to the lower edge than the belt line BL is not visible from inside and outside the vehicle, and thus the appearance of the laminated glass 10 will not deteriorate.

In a plan view, at least at the upper edge portion and both side edge portions of the laminated glass 10, the distance L₂ from the periphery of the second substrate 165 constituting the light control film 16 to the periphery of the pair of glass plates is preferably at most 5 mm. When both the distances L₁ and L₂ are at most 5 mm, both the periphery of the first substrate 161 and the periphery of the second substrate 165 will be less noticeable, and deterioration of the appearance of the laminated glass 10 as viewed from inside or outside the vehicle can be more suppressed. The distance L₂ may be set to such a value at least at the upper edge portion of the laminated glass 10 and both side edge portions of the laminated glass 10 located closer to the upper edge portion than the belt line BL, in a plan view when the laminated glass 10 is installed on the vehicle.

In a plan view, at the lower edge portion and at a portion closer to the lower edge portion than the upper edge portion of both side edge portions of the laminated glass 10, the distance from the periphery of the second substrate 165 to the periphery of the pair of glass plates may be longer than 5 mm. The distance from the periphery of the pair of glass plates to the periphery of the second substrate 165 may be set to such a value at least at the lower edge portion of the laminated glass 10 and both side edge portions of the laminated glass 10 located closer to the lower edge portion than the belt line BL, in a plan view when the laminated glass 10 is installed on the vehicle. This is because both side edge portions closer to the lower edge portion than the belt line BL are not visible from inside and outside the vehicle, and thus the appearance of the laminated glass 10 will not deteriorate.

In a plan view, at least at the upper edge portion and both side edge portions of the laminated glass 10, the distance L₂ from the periphery of the second substrate 165 to the periphery of the pair of glass plates may be at most 4 mm, may be at most 3 mm, may be at most 2 mm, and may be at most 1 mm. Further, in a plan view, at least at the upper edge portion and both side edge portions of the laminated glass 10, the periphery of the second substrate 165 may agree with the periphery of the pair of glass plates. That is, the distance L₂ may be 0. The closer to 0 the distance L₁ is, the higher the effect to suppress deterioration of the appearance of the laminated glass 10 as viewed from inside or outside the vehicle will be. The distance L₂ may be set to such a value at least at the upper edge portion of the laminated glass 10 and at both side edge portions of the laminated glass 10 located closer to the upper edge portion than the belt line BL, in a plan view when the laminated glass 10 is installed on the vehicle.

In a plan view, the distance from the periphery of the first substrate 161 to the periphery of the light control layer 163 is preferably at most 5 mm. Further, in a plan view, the distance from the periphery of the pair of glass plates to the periphery of the light control layer 163 is preferably equal to the distance L₂ from the periphery of the pair of glass plates to the periphery of the second substrate 165, whereby the main surface of the second conductive layer 164 will not be exposed from the second substrate 165, and the risk of short-circuiting of the second conductive layer 164 with other members can be reduced. Further, in a plan view, the distance from the periphery of the pair of glass plates to the periphery of the light control layer 163 may be larger than the distance L₂ from the periphery of the pair of glass plates to the periphery of the second substrate 165.

In the example of the laminated glass 10 shown in FIGS. 1A and 1B and FIG. 2, in a plan view, the distance from the periphery of the pair of glass plates to the periphery of the second substrate 165 is longer than the distance from the periphery of the pair of glass plates to the periphery of the first substrate 161. And, the sealing material 166 is in contact with the main surface of the first substrate 161 and the peripheral side surface of the second substrate 165. In such a case, since the sealing material 166 is in contact with only the peripheral side surface of the second substrate 165 among the peripheral side surface of the first substrate 161 and the peripheral side surface of the second substrate 165, there is no interface between the sealing material 166 and the peripheral side surface of the first substrate 161. As a result, deterioration of the appearance of the laminated glass 10 as viewed from inside or outside the vehicle can be more suppressed. The case where “the sealing material 166 is in contact with the main surface of the first substrate 161” includes both a case where the sealing material 166 is in direct contact with the main surface of the first substrate 161 and a case where the sealing material 166 is in indirect contact with the main surface of the first substrate 161 via another layer.

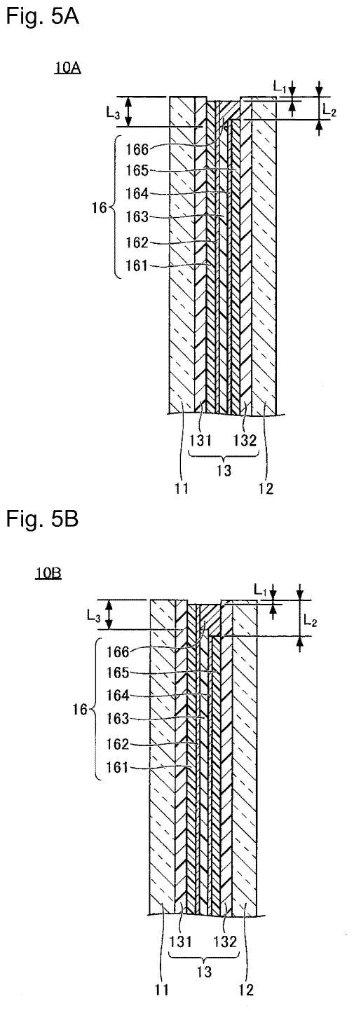

However, as in the laminated glass 10A shown in FIG. 5A, in a plan view, the distance L₃ from the periphery of the pair of glass plates to the periphery of the light control layer 163 may be longer than the distance L₁ from the periphery of the pair of glass plates to the periphery of the first substrate 161 and the distance L₂ from the periphery of the pair of glass plates to the periphery of the second substrate 165. Further, as in the laminated glass 10B shown in FIG. 5B, in a plan view, the distance L₃ from the periphery of the pair of glass plates to the periphery of the light control layer 163 may be longer than the distance L₁ from the periphery of the pair of glass plates to the periphery of the first substrate 161 and shorter than the distance L₂ from the periphery of the pair of glass plates to the periphery of the second substrate 165. In either case, the distance L₃ is, for example, preferably at most 5 mm. In the examples shown in FIGS. 5A and 5B, since the periphery of the light control layer 163 and the periphery of the second substrate 165 do not agree with each other, the peripheries of the light control layer 163 and the second substrate 165 are less visible from inside and outside the vehicle.

Further, in all cases shown in FIGS. 1A to 5B, the sealing material 166 overlaps with the first substrate 161 in a plan view, and thus ultraviolet light applied from outside the vehicle is transmitted through the first substrate 161 before it enters the sealing material 166, and thus the net amount of ultraviolet light which enters the sealing material 166 can be reduced, whereby deterioration of the sealing material 166 due to ultraviolet light can be suppressed. Further, in a case where an ultraviolet absorbing layer is provided between the first substrate 161 and the light control layer 163 of the light control film 16, deterioration of the sealing material 166 due to ultraviolet light can further be suppressed. Suppression of deterioration of the sealing material 166 directly contributes to suppression of deterioration of the appearance of the laminated glass as viewed from inside or outside the vehicle, and indirectly contributes to suppression of deterioration of the light control layer 163.

In a conventional laminated glass, in a case where the light control film is disposed so that the periphery of the light control film is located inside the periphery of the glass plate, a frame-shaped interlayer may sometimes be disposed at a step between the peripheral portion of the light control film and the periphery of the glass plate. However, since the frame-shaped interlayer is thin, its handling and positioning in lamination step for preparation of the laminated glass are difficult. In all of the laminated glasses shown in FIGS. 1A to 5B, it is not necessary to use a frame-shaped interlayer, and the lamination step for preparation of the laminated glass can be conducted efficiently.

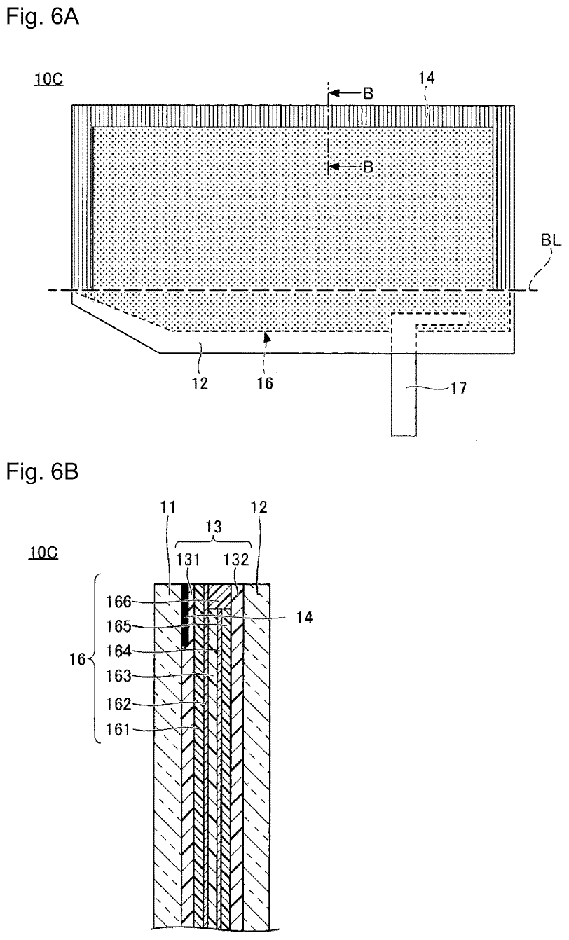

FIGS. 6A and 6B are views illustrating a laminated glass in a modified example according to the first embodiment. FIG. 6A is a view schematically illustrating the laminated glass as seen from the normal direction of the second glass plate, and FIG. 6B is a partially enlarged cross-sectional view along the line B-B in FIG. 6A.

As shown in FIG. 6B, the laminated glass 10C is different from the laminated glass 10 (see FIG. 1B) in that it has a shielding layer 14 at the peripheral portion of the laminated glass 10C, at least at a portion closer to the upper edge portion than the belt line BL.

The shielding layer 14 is an opaque layer and is provided, for example, in a strip shape along the peripheral portion of the laminated glass 10C at least at a portion of the laminated glass closer to the upper edge portion than the belt line BL. The shielding layer 14 may, for example, be an opaque colored ceramic layer (colored enamel layer). The color of the shielding layer is optional, and is preferably deep color such as black, brown, gray or navy, or white, and is more preferably black. The shielding layer 14 may be a colored interlayer having light shielding property, a colored film, a combination of a colored interlayer and a colored ceramic layer, or a layer having light control function. The colored interlayer may be an entirely colored interlayer, or may be an interlayer having only its surface colored. The same applies to the colored film. The colored film may be integrated with e.g. an infrared reflecting film.

By providing the shielding layer 14 with an appropriate width, not only the periphery of the first substrate 161 and the periphery of the second substrate 165 can be shielded but also deterioration of the sealing material 166 due to ultraviolet light can be suppressed. In a plan view, the width of the shielding layer 14 is preferably at most 15 mm. The shielding layer 14 is located preferably in a region of at most 15 mm from the periphery of the pair of glass plates. That is, the width of the shielding layer 14 in a plan view is preferably at most 15 mm, whereby a favorable field of view can be secured. The width of the shielding layer 14 in a plan view is more preferably at most 10 mm, more preferably at most 5 mm, whereby a more favorable field of view can be secured.

In a case where the laminated glass 10C is used as a slidable window glass, the width of the shielding layer 14 is preferably such that the whole shielding layer 14 is in a range shielded by the glass run, when the laminated glass 10C is moved to the uppermost portion and the upper edge portion is held by the glass run, whereby in a state where the laminated glass 10C is close, the shielding layer 14 is not visible from inside or outside the vehicle, and a favorable field of view can be secured.

The shielding layer 14 may be formed, for example in the case of a colored ceramic layer, by applying a ceramic color paste containing fusible glass frit containing a black pigment on a glass plate e.g. by screen printing, followed by firing, but its formation is not limited thereto. The shielding layer 14 may be formed, for example, by applying an organic ink containing a dark color pigment or a white pigment on a glass plate e.g. by screen printing, followed by drying. The shielding layer 14 may be formed also by ink jet printing.

The shielding layer 14 may be provided, for example, only on the peripheral portion of the main surface on the vehicle interior side of the first glass plate 11. However, the shielding layer 14 may be provided only on the peripheral portion of the main surface on the vehicle interior side of the second glass plate 12, or may be provided on both the peripheral portion of the main surface on the vehicle interior side of the first glass plate 11 and the peripheral portion of the main surface on the vehicle interior side of the second glass plate 12.

Now, the first glass plate 11, the second glass plate 12 and the interlayer 13 will be described in detail.

### [Glass Plates]

The first glass plate 11 and the second glass plate 12 may be formed of inorganic glass or organic glass. Inorganic glass and organic glass are usually colorless. Inorganic glass and organic glass may be colored so long as they are transparent. Inorganic glass and organic glass may be glass absorbing ultraviolet light or infrared rays.

As the inorganic glass, for example, soda-lime glass, aluminosilicate glass, borosilicate glass, alkali-free glass, quartz glass, etc. may be used without any particular restrictions. At least the first glass plate 11, which is located on the outermost side of the laminated glass 10, is preferably formed of inorganic glass from the viewpoint of scratch resistance, and, from the viewpoint of formability, it is preferably formed of soda-lime glass. In a case where the first glass plate 11 and the second glass plate 12 are formed of soda-lime glass, clear glass, green glass containing at least a certain amount of an iron component, and UV-cut green glass, can be used suitably. At least one of the first glass plate 11 and the second glass plate 12 may also be so-called privacy glass having a dark color such as gray. Privacy glass is described in detail, for example, in WO2015/088026, the contents of which may be used in this specification as reference.

The inorganic glass may be either untempered glass or tempered glass. Untempered glass is one made by forming molten glass into a plate, followed by annealing. Tempered glass is one having a compressive stress layer formed on the surface of untempered glass.

Tempered glass may, for example, be either physically tempered glass, such as air tempered glass, or chemically tempered glass. In the case of physically tempered glass, the glass surface can be strengthened by generating a compressive stress layer on the glass surface due to the temperature difference between the glass surface and the glass interior by operations other than annealing, for example, by rapidly cooling a uniformly heated glass plate from a temperature near its softening point in bending.

In the case of chemically tempered glass, for example, the glass surface can be strengthened by inducing compressive stress on the glass surface by ion exchange after bending.

On the other hand, as materials for organic glass, transparent resins, such as a polycarbonate, e.g. an acrylic resin such as polymethyl methacrylate, polyvinyl chloride, polystyrene, etc. may be mentioned.

The forming method for the first glass plate 11 and the second glass plate 12 is not particularly limited, and, for example, in the case of inorganic glass, it is preferred to use a glass plate formed by the float process or the like. The shapes of the first glass plate 11 and the second glass plate 12 are not limited to rectangular or trapezoidal shapes, but may be shapes processed into various shapes and curvatures.

The thickness of the first glass plate 11 is preferably at least 1.1 mm and at most 3 mm. When the thickness of the first glass plate 11 is at least 1.1 mm, the strength is sufficient in terms of resistance to flying stones, etc. When the thickness of the first glass plate 11 is at most 3 mm, the mass of the laminated glass 10 is not too large, which is desirable in terms of fuel consumption of the vehicle. The thickness of the first glass plate 11 is more preferably at least 1.8 mm and at most 2.8 mm, further preferably at least 1.8 mm and at most 2.6 mm, even more preferably at least 1.8 mm and at most 2.2 mm, still further preferably at least 1.8 mm and at most 2.0 mm.

The thickness of the second glass plate 12 is preferably at least 0.3 mm and at most 2.3 mm. When the thickness of the second glass plate 12 is at least 0.3 mm, the handling efficiency will be good. When the thickness of the second glass plate is at most 2.3 mm, the mass will not be too large.

Further, in a case where the thickness of the second glass plate 12 is not appropriate, if two pieces of glass with particularly deep bends as the first glass plate 11 and the second glass plate 12 are formed, a mismatch will be caused in the shapes of the two pieces, which will significantly affect the glass quality such as residual stress after pressure-bonding.

However, the glass quality, such as residual stress, can be maintained by adjusting the thickness of the second glass plate 12 to be at least 0.3 mm and at most 2.3 mm. To adjust the thickness of the second glass plate 12 to be at least 0.3 mm and at most 2.3 mm is particularly effective in maintaining glass quality in deeply bent glass. The thickness of the second glass plate 12 is more preferably at least 0.5 mm and at most 2.1 mm, further preferably at least 0.7 mm and at most 1.9 mm. Within such a range, the above effects will be more remarkable.

On the outside of the first glass plate 11 and/or the second glass plate 12, a film having water repellency, ultraviolet or infrared ray cutting function, or a film having low reflective or low emissive characteristics, may be provided. Further, on the side in contact with the interlayer 13, of the first glass plate 11 and/or the second glass plate 12, a film that cuts ultraviolet or infrared rays, has low emissive properties or visible light absorptivity, or is colored, may be provided.

In a case where the first glass plate 11 and the second glass plate 12 are formed of curved inorganic glass, the first glass plate 11 and the second glass plate 12 are bent, after formed by the float process, before bonding with the interlayer 13. Bending is conducted by softening the glass by heating it. The heating temperature of the glass during bending is preferably controlled in the range of approximately from 550° C. to 700° C. Gravity forming, press forming, roller forming, etc. may be used for bending of the first glass plate 11 and the second glass plate 12.

### [Interlayer]

As the interlayer 13, thermoplastic resins are often used, and thermoplastic resins that have been used for this type of application, for example, a plasticized polyvinyl acetal resin, a plasticized polyvinyl chloride resin, a saturated polyester resin, a plasticized saturated polyester resin, a polyurethane resin, a plasticized polyurethane resin, an ethylene/vinyl acetate copolymer resin, an ethylene/ethyl acrylate copolymer resin, a cycloolefin polymer resin, an ionomer resin, etc., may be mentioned. Further, a resin composition containing a modified block copolymer hydride as described in Japanese Patent No. 6065221 may also be suitably used.

Among these, plasticized polyvinyl acetal resins are suitably used, because they are excellent in balance of various properties such as transparency, weather resistance, strength, bonding strength, penetration resistance, impact energy absorption, moisture resistance, heat insulation, and sound insulation properties. These thermoplastic resins may be used alone, or two or more of them may be used in combination. The term “plasticized” in the above plasticized polyvinyl acetal resins means that they are plasticized by the addition of a plasticizer. The same applies to other plasticized resins.

However, when a certain object is to be sealed in the interlayer 13, depending on the type of the object to be sealed, it may be degraded by a certain plasticizer, and in such a case, it is preferred to use a resin containing substantially no such a plasticizer. As the resin containing no plasticizer, for example, an ethylene/vinyl acetate copolymer (EVA) resin or the like may be mentioned.

As the above polyvinyl acetal resins, a polyvinyl formal resin obtainable by reacting polyvinyl alcohol (PVA) with formaldehyde, a polyvinyl acetal resin in the narrow sense obtainable by reacting PVA with acetaldehyde, a polyvinyl butyral (PVB) resin obtainable by reacting PVA with n-butyl aldehyde, etc. may be mentioned, and PVB is particularly suitable, since it is excellent in balance of various properties, such as transparency, weather resistance, strength, bonding strength, penetration resistance, impact energy absorption, moisture resistance, heat insulation and sound insulation properties. Further, these polyvinyl acetal resins may be used alone, or two or more types may be used in combination.

However, the material for forming the interlayer 13 is not limited to a thermoplastic resin. The interlayer 13 may contain functional particles such as infrared absorbers, ultraviolet absorbers, luminescent agents, etc. Further, the interlayer 13 may have a colored portion called a shade band. The coloring pigment to be used to form the colored portion, may be one that can be used for plastics, and the amount of addition may be adjusted so that the visible light transmittance of the colored portion will be at most 40%. As the coloring pigment, for example, an organic coloring pigment of azo type, phthalocyanine type, quinacridone type, perylene type, perinone type, dioxazine type, anthraquinone type, or isoindolinone type, or an inorganic coloring pigment such as an oxide, a hydroxide, a sulfide, a chromate, a sulfate, a carbonate, a silicate, a phosphate, an arsenate, a ferrocyanide, carbon or metal powder may be mentioned. These color pigments may be used alone, or two or more types may be used in combination.

The interlayer 13 may have three or more layers. For example, when the interlayer is formed of three or more layers and the shear modulus of any layer excluding both side layers is made to be smaller than the shear modulus of both side layers e.g. by adjusting the plasticizer, the sound insulation of the laminated glass 10 can be improved. In such a case, the shear moduli of both side layers may be the same or different.

The thickness of the interlayer 13 is preferably at least 0.5 mm at the thinnest portion. Here, in a case where the interlayer 13 has multiple layers, the thickness of the interlayer 13 is the total of the thicknesses of the respective layers. When the thickness of the thinnest portion of the interlayer 13 is at least 0.5 mm, the impact resistance required for laminated glass will be sufficient. Further, the thickness of the interlayer 13 is preferably at most 3 mm at the thickest portion. When the maximum value of the thickness of the interlayer 13 is at most 3 mm, the mass of the laminated glass will not become too large. The maximum value of the thickness of the interlayer 13 is more preferably at most 2.8 mm, further preferably at most 2.6 mm.

Further, in a case where the interlayer 13 has multiple layers, the respective layers contained in the interlayer 13 are preferably formed of the same material, but may be formed of different materials. However, from the viewpoint of adhesion to the first glass plate 11 and the second glass plate 12, and functional material to be included in the laminated glass 10, it is desirable that the portion corresponding to at least 50% in the thickness of the interlayer 13 be formed of the above-mentioned materials.

To prepare the interlayer 13, for example, the above resin materials to become the interlayer are suitably selected and extruded in a heated molten state by using an extruder. The extrusion conditions such as an extrusion speed, etc. are set so that the interlayer 13 is uniformly prepared. Then, the extruded resin film is, for example, stretched as the case requires to give curvature to the upper and lower edges in accordance with the design of the laminated glass, to complete the interlayer 13.

### [Laminated Glass]

The total thickness of the laminated glass 10 is, for example at least 1.9 mm and at most 10 mm, preferably at least 2.8 mm and at most 10 mm. When the total thickness of the laminated glass 10 is at least 2.8 mm, sufficient rigidity can be secured. When the total thickness of the laminated glass 10 is at most 10 mm, sufficient transmittance can be obtained, and haze can be reduced.

On at least one side of the laminated glass 10, the plate misalignment between the first glass plate 11 and the second glass plate 12 is preferably at most 1.5 mm, more preferably at most 1 mm. Here, the plate misalignment between the first glass plate 11 and the second glass plate 12 is the amount of misalignment between the peripheral side surface of the first glass plate 11 and the peripheral side surface of the second glass plate 12 in a plan view.

On at least one side of the laminated glass 10, the plate misalignment between the first glass plate 11 and the second glass plate 12 is preferably at most 1.5 mm, in order not to impair the appearance. On at least one side of the laminated glass 10, the plate misalignment between the first glass plate 11 and the second glass plate 12 is more preferably at most 1.0 mm, in order not to impair the appearance. Here, on the lower side of the laminated glass 10, the plate misalignment between the first glass plate 11 and the second glass plate 12 may exceed 1.0 mm. At least one of the first glass plate 11 and the second glass plate 12 may have a through hole in order to firmly attach a holder 160, etc. as described later.

To produce the laminated glass 10, a first interlayer 131, a light control film 16 and a second interlayer 132 are sandwiched between the first glass plate 11 and the second glass plate 12 to form a laminate. And, for example, this laminate is placed in a rubber bag, rubber chamber or resin bag, and bonded in a vacuum having the gauge pressure controlled in a range of from −100 kPa to −65 kPa and controlling the temperature in a range of from about 70° C. to 110° C. The heating conditions, temperature conditions, and lamination method may suitably be selected.

Further, for example, by applying pressure bonding treatment of heating and pressurizing under conditions having the temperature controlled within a range of from 100° C. to 150° C. and the absolute pressure controlled within a range of from 0.6 MPa to 1.3 MPa, a laminated glass 10 more excellent in durability can be obtained. However, in some cases, there may be a case where this heating and pressurizing process may not be used in consideration of simplification of the process and the characteristics of the materials to be sealed in the laminated glass 10.

A method called “cold bending” may be used, in which the first glass plate 11 and the second glass plate 12 are bonded in a state where either one or both of them are elastically deformed each other. Cold bending can be achieved by using a laminate having the first glass plate 11, the interlayer 13, and the second glass plate 12 fixed by temporary fixing means such as a tape, and a conventionally known nip roller or pre-compression device such as a rubber bag, rubber chamber, etc. and an autoclave.

Between the first glass plate 11 and the second glass plate 12, to such an extent that the effects of the present application will not be impaired, in addition to the interlayer 13 and the light control film 16, there may be a film or a device having a function such as electric heating, luminescence, power generation, touch panel, decoration, polarization, light reflection, light scattering, light absorption, etc. The light here means any of infrared light, visible light and ultraviolet light. Light reflection is, for example, reflection of infrared light, and light scattering is, for example, scattering of visible light. Further, the surface of the laminated glass 10 may have a film having a function such as antifogging, water repellency, heat shielding, low reflection, etc. Further, the main surface of the first glass plate 11 and the main surface of the second glass plate 12 may have a film having a function such as heat shielding, heat emission, etc.

### [Vehicular Window Structure]

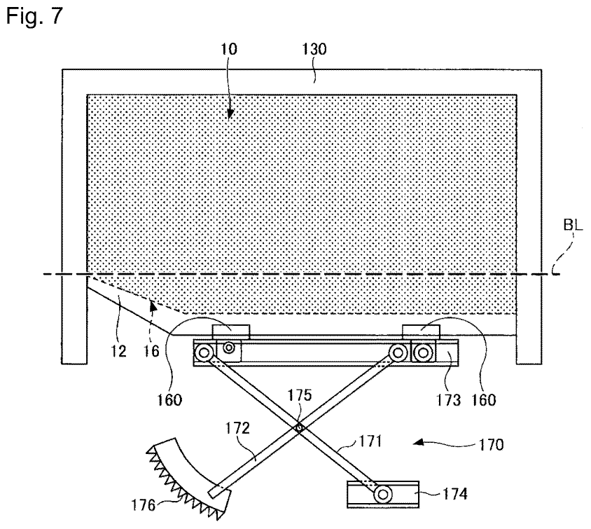

FIG. 7 is a schematic view illustrating a vehicular window structure. As shown in FIG. 7, in a case where the laminated glass 10 is a door glass slidable in an up-and-down direction, a holder 160 and a lifting device 170 are disposed inside the door panel. Further, mainly above the lifting device 170, a glass run 130 that holds the upper edge portion and both side edge portions of the laminated glass 10 is disposed.

In FIG. 7, the laminated glass 10 slidable in an up-and-down direction, is shown in the completely closed state (i.e. the state located at the uppermost side). In the state shown in FIG. 7, the upper edge portion and both side edge portions of the laminated glass 10 are held by the glass run 130. Here, even in a state where the laminated glass 10 is completely closed, the lower side of the laminated glass 10 below the belt line BL will not be exposed to the outside because it is located inside the door panel.

The glass run 130 has a region which overlaps with at least a part of the pair of glass plates in a plan view, and the periphery of the first substrate 161 and the periphery of the second substrate 165 preferably overlap with this region, whereby the peripheries of the first substrate 161 and the second substrate 165 are shielded by the glass run 130, and thus deterioration of the appearance of the laminated glass 10 as viewed from inside or outside the vehicle can be suppressed. Further, the periphery of the sealing material 166 preferably overlaps with this region, and the periphery of the light control film 16 preferably overlaps with this region.

The holder 160 is a support member that slidably supports the laminated glass 10. The holder 160 is formed, for example, of a metal or a resin and supports at least one of the pair of glass plates. Specifically, the holder 160 supports, for example, the bottom edge of the laminated glass 10 and further extends from the bottom edge to the lower edge portion of the first glass plate 11 and/or the second glass plate 12 to support the lower edge portion of the first glass plate 11 and/or the second glass plate 12. Alternatively, without supporting the bottom edge of the laminated glass 10, the holder 160 may support the laminated glass 10 by holding the pair of glass plates from both sides. Further, the material of the holder 160 is not limited to a metal or a resin.

In a plan view, at least one of the pair of glass plates has a region which overlaps with the holder 160. The light control layer 163 of the light control film 16 preferably does not overlap with the region. That is, in a plan view, the 160 is disposed preferably so as not to overlap with the light control layer 163. By such disposition, impact by the holder 160 is less likely to be transmitted to the light control layer 163, whereby not only durability of the light control layer 163 improves but also a local change of the transmittance of the light control layer 163 is less likely to occur.

The lifting device 170 is a device which slides the laminated glass 10 up and down along the glass run 130 to raise and lower the laminated glass 10. The lifting device 170 is, for example, an arm-type regulator, composed of two arms 171 and 172, a lifting rail 173, a fixed rail 174, and the like. The holder 160 is attached to the lifting rail 173 of the lifting device 170.

The two arms 171 and 172 are connected to each other, to be rotatable around a fulcrum 175. The lifting rail 173 is a rail that extends horizontally and can be raised and lowered against the vehicle door. The upper ends of the arms 171 and 172 are both horizontally slidably attached to the lifting rail 173. Further, the fixed rail 174 is a rail that extends horizontally and is fixed to the door of the vehicle.

The lower end of the arm 171 is attached horizontally slidably on the fixed rail 174, and the lower end of the arm 172 is connected to a regulator via a gear 176. In such a construction, when the gear 176 is driven via the regulator, the arms 171 and 172 rotate around the fulcrum 175 to raise and lower the lifting rail 173. Here, the lifting device 170 is not limited to this construction, and may be a lifting device using wires, etc.

In the forgoing, the preferred embodiments, etc. have been described in detail, but without being limited to the above described embodiments, etc., various variations and substitutions may be made to the above described embodiments, etc., without departing from the scope of the claims.

### REFERENCE SYMBOLS

10, 10A, 10B, 10C: Laminated glass
11: First glass plate
12: Second glass plate
13: Interlayer
14: Shielding layer
16: Light control film
17: Wiring
131: First interlayer
132: Second interlayer
160: Holder
161: First substrate
162: First conductive layer
163: Light control layer
164: Second conductive layer
165: Second substrate
166: Sealing material
170: Lifting device
171,172: Arm
173: Lifting rail
174: Fixed rail
175: Fulcrum
176: Gears
261, 262: Ultraviolet absorbing layer
263: Coating layer
264: Transparent adhesive material
265: Third substrate

What is claimed is:

1. A vehicular laminated glass comprising a pair of glass plates provided to face each other, an interlayer provided between the pair of glass plates, and a light control film capable of switching the visible light transmittance provided inside the interlayer,
wherein the light control film has a first substrate and a second substrate provided to face each other, a light control layer provided between the first substrate and the second substrate, and a sealing material provided on the periphery of the light control layer, and
in a plan view, at least a part of the periphery of the light control film is away from the periphery of the pair of glass plates with a distance of at most 5 mm.

2. The vehicular laminated glass according to claim 1, wherein in a plan view, the distance from the periphery of the pair of glass plates to the periphery of the second substrate is longer than the distance from the periphery of the pair of glass plates to the periphery of the first substrate, and
the sealing material is in contact with the main surface of the first substrate and the peripheral side surface of the second substrate.

3. The vehicular laminated glass according to claim 1, wherein in a plan view, at least a part of the periphery of the first substrate agrees with the periphery of the pair of glass plates.

4. The vehicular laminated glass according to claim 3, wherein in a plan view, the distance from the periphery of the pair of glass plates to the periphery of the second substrate is at most 5 mm.

5. The vehicular laminated glass according to claim 1, wherein in a plan view, the distance from the periphery of the first substrate to the periphery of the light control layer is at most 5 mm.

6. The vehicular laminated glass according to claim 1, wherein in a plan view, the distance from the periphery of the pair of glass plates to the periphery of the light control layer is equal to the distance from the periphery of the pair of glass plates to the periphery of the second substrate.

7. The vehicular laminated glass according to claim 1, wherein in a plan view, the distance from the periphery of the pair of glass plates to the periphery of the light control layer is,
longer than the distance from the periphery of the pair of glass plates to the periphery of the first substrate and the distance from the periphery of the pair of glass plates to the periphery of the second substrate, or
longer than the distance from the periphery of the pair of glass plates to the periphery of the first substrate and shorter than the distance from the periphery of the pair of glass plates to the periphery of the second substrate.

8. The vehicular laminated glass according to claim 1, wherein in a plan view, the distance from the periphery of the pair of glass plates to the periphery of the first substrate at both side edge portions of the vehicular laminated glass, is longer than the distance from the periphery of the pair of glass plates to the periphery of the first substrate at the upper edge portion of the vehicular laminated glass.

9. The vehicular laminated glass according to claim 1, wherein the second substrate is disposed on the vehicle interior side than the first substrate when the vehicular laminated glass is installed on a vehicle.

10. The vehicular laminated glass according to claim 1, wherein the light control film has an ultraviolet absorbing layer at least one of between the first substrate and the light control layer and between the second substrate and the light control layer.

11. The vehicular laminated glass according to claim 1, wherein the sealing material is constituted by a foil-shaped member having a resin substrate and an adhesive layer on the main surface of the resin substrate.

12. The vehicular laminated glass according to claim 1, wherein the sealing material contains a curable resin.

13. The vehicular laminated glass according to claim 1, wherein the pair of glass plates has a visible light transmittance of at least 5% at its peripheral portion.

14. The vehicular laminated glass according to claim 1,
which has a shielding layer on the peripheral portion of the pair of glass plates, and
wherein the shielding layer is located in a region of at most 15 mm from the periphery of the pair of glass plates.

15. A vehicular window structure, comprising the vehicular laminated glass as defined in claim 1, and a support member which supports at least one of the pair of glass plates.

16. The vehicular window structure according to claim 15,
wherein in a plan view, the pair of glass plates has a first region which overlaps with the support member, and
the light control layer does not overlap with the first region.

17. The vehicular window structure according to claim 15, which has a lifting device which raises and lowers the vehicular laminated glass.

18. The vehicular window structure according to claim 15,
which has a glass run,
wherein the glass run has a second region which overlaps with at least a part of the pair of glass plates in a plan view, and
the periphery of the first substrate and the periphery of the second substrate overlap with the second region.
